(19) United States
(12) Patent Application Publication
(10) Pub. No.: US 2008/0131358 A1
(43) Pub. Date: Jun. 5, 2008

(54) Lime recovery

(75) Inventors: Len Woida, Marietta, GA (US); Walter Hawkins, Green Bay, WI (US)

Correspondence Address: WEISS & WEISS, Suite 251, 300 Old Country Road, Mineola, NY, 11501, US

(73) Assignee: Feeco International, Inc.

(21) Appl. No.: 11/606,542

(22) Filed: Nov. 30, 2006

(51) Int. Cl. C01F 11/04

(52) U.S. Cl. 423/637

(57) ABSTRACT

A lime recovery process which mixes dry recycle with spent lime sludge (SLS) forming wet agglomerated calcium carbonate (CaCO₃) followed by drying and calcination to produce a reactive lime (CaO) product.

### FIELD OF THE INVENTION

The present invention relates to a lime recovery process which mixes dry recycle with spent lime sludge (SLS) forming wet agglomerated calcium carbonate (CaCO₃) followed by drying and calcination to produce a reactive lime (CaO) product.

### BACKGROUND OF THE INVENTION

Calcium carbonate (CaCO₃) sludge is currently calcined to lime (CaO) in large, high temperature rotary kilns. Minimal amounts of non-process elements (NPE) like magnesium oxide, aluminum oxide, silicon dioxide, manganese oxide, and iron oxides in these sludges make processing of these sludges difficult in conventional calcination processes.

The practice of calcining Spent Lime Sludge (SLS) in rotary kilns for recovery of CaO from CaCO₃ is well known and widely practiced. Current technologies have very significant limitations on the quality and chemistry of said spent lime sludges (SLS) that can be treated. In particular, SLS's that contain even low quantities of non-process elements (NPE) like magnesium oxide, aluminum oxide, silicon dioxide, manganese oxide, and iron oxides exhibit poor performance in their ability to be mechanically dewatered and transported. Minor amounts of magnesium carbonate or similar handling NPEs in spent lime sludges have proven to be very deleterious in conventional lime kiln technologies. Magnesium carbonate content in excess of 1.6% (as expressed in terms of MgO) has proven to cause significant process problems, among them the ability of sludges to be properly dewatered and adequately transferred into and through the feed ends of kilns. Similarly; levels of Al₂O₃ above 0.25%, levels of SiO₂ above 0.25%, levels of Mn above 0.003% and levels of Fe above 0.07% have been shown to have deleterious impact upon SLS thermal processing in lime recovery kilns.

Prior to calcination, SLS feed material is initially taken from storage tanks and mechanically dewatered to about 65 to 85% solids content. The resultant still water bearing sludge is very sticky and difficult to handle. Levels of NPEs above those mentioned above might require two dewatering devices versus a single unit for lower NPE content feedstocks. Low NPE sludges utilizing a single dewatering device have been able to attain 85% solids content. High NPE bearing sludges utilizing two dewatering devices have operated with solid contents lower than 70%.

Currently, partially dewatered 65% to 85% solids SLS cake is then fed directly into countercurrent flow rotary kilns or external dryers that feed the kilns. As partially dried, high NPE cakes are fed into conventional practice lime recovery kilns, material builds up on the kiln shells forming “mud rings” or coatings on kiln shells that haven proven to be impediments to kiln operation. Present day lime recovery kilns employ a series of suspended chains as a method of countering this problem, but only with a very marginal level of success.

Partially dry sludges either enter a section of kilns that contain a multitude of chains that aid in SLS drying and the break-up of overly clumpy material or they simply enter at the feed end of the kilns without chains in the event that external dryers are utilized. In some cases both an external dryer and chain zone located inside of the kiln may be concurrently utilized.

The first kiln zone is principally the water removal stage. Thermally, this section is less efficient than a conventional rotary dryer which showers a curtain of material through the cross sectional above bed area of the cylinder maximizing utilization of high heat content countercurrent process gases.

Dried material exits the drying portion of kilns or external preheaters and enters the next section of kilns and is heated to in excess of 1650° F. to remove chemically bound CO₂ and produce lime (CaO). This happens in the reactive calcination portion of the vessel. Typical kiln exit gas dust loses range between 12 and 30% of the feed rate due to the very fine nature of the raw feed material. In some cases dust is returned into the feed end of kilns via cyclones and/or electrostatic precipitators. In other cases it exits the system for cleaning in wet scrubbers.

In summary, operators of conventional lime kilns have observed kilns becoming completely, or significantly restricted by heavy material deposits and coatings commonly termed mud rings As a result of these inherent problems, the industry has resorted to restricting the amount of magnesium carbonate and the forementioned NPEs that enter the system. The additional cost of capital equipment and build up issues makes this a severe problem for the industry. The added quality constraint of very low dolomitic lime (magnesium carbonate) content lime has caused significant increased costs of raw material procurement.

U.S. Pat. No. 5,824,244 (Kelly) also describes a process for regeneration of sodium contaminated calcium carbonate (CaCO₃) particles. The Kelly process does not however use a rotary kiln but involves a compactor that forms a dry outer shell that then enters a specialized downward path responsive to gravity kiln or shaft kiln.

Kelly teaches mechanical compaction as the method of forming discrete agglomerates that have outer portions and inner portions. The outer layer of the agglomerates form a dry outer layer that is fed into a very specific calciner that Kelly believes can handle the SLS sludge. This process creates excessive fines. By forming an outer shell these agglomerates are sealing in the moisture. The moisture must escape and in doing so cracks/shatters the exterior wall creating unwanted fines in the calciner.

If the compactor still cannot handle the sludge, Kelly must add a predryer to the system prior to it entering the compactor. Then if that is not good enough to handle the sludge in the calciner, Kelly moves the agglomerates to a post dryer zone to dry at least the surfaces of the agglomerate to a degree which prevents adjacent agglomerates from sticking to one another.

This precalcination process is costly. Compactors are expensive to buy, expensive to operate and expensive to maintain. Both electrical and gas consumption is high. The process may still require a predryer and may also require a post dryer.

The calciner must be a downward path responsive to gravity reaction vessel. The problem with this type of calciner is that it tends to channel air and limits product quality.

U.S. Pat. No. 6,310,129 relates to a composition of thermo plastic polymer and powered dried carbide lime. The composition may comprise 5-60 parts by weight of powdered dried carbide lime, 20-95 parts by weight of at least 1 thermoplastic material selected from the group consisting of thermoplastic polymer, thermoplastic elastomer, and thermoplastic rubber; and 0-60 parts by weight of at least one additive selected from lubricants, stabilizer, anti-oxidants, plasticizers, pigments and dyes, anti-blocking, antic-static, blowing and release agents, flame retardants, impact modifiers, coupling and wetting agents, other processing aids and fibrous reinforcing agents.

U.S. patent publication No. 2003/0099591 relates to a process for generation of finely divided calcium carbonate rich industrial byproduct. The process adopts purification steps of thermal treatment, pulverization and coating using emulation of fatty acid or its derivatives.

### SUMMARY OF THE INVENTION

The present invention relates to a process for reclaiming spent lime sludge (SLS) which consists essentially of calcium carbonate (CaCO₃) particles, water and other particulates. The process comprises bringing all contents of the SLS sludge into a mixer. Dry recycle is added along with a binder to the SLS sludge. Calcium carbonate agglomerates are formed and then the agglomerates are predried and calcined.

It is an object of the present invention for the process to further comprise: adding a binding agent to the mixer, wherein the binder is selected from the group consisting of: Bentonite Clay, Polyacrylamides, Precipitated Calcium Carbonate, Sodium Silicate, Sodium Lignosulfonate, Molasses, Starch, Sugar, Hydrated lime, and any combination of the above.

It is an object of the present invention for the mixer to comprise at least two or more mixers or 1 mixer and 1 agglomerating piece of equipment.

It is an object of the present invention for the calcining to take place in one of the following calciners: Rotary Kiln, Fluid Bed, or Shaft Kiln.

It is an object of the present invention for the recycle to contain one or more of: calcium carbonate or calcium oxide.

It is an object of the present invention for the treatment of SLS filter cake to contain magnesium contaminates.

It is an object of the present invention for the treatment of SLS filter cake to contain sodium contaminates.

It is an object of the present invention for polyacrylamides to be added to the process.

It is an object of the present invention for the SLS sludge to contain one or more of PCB's, Furans, or Dioxins

It is an object of the present invention for the above process to minimize dust in the calciner.

It is an object of the present invention for the above process to eliminate/minimize buildup in the calciner.

It is an object of the present invention for a greater calcium carbonate to CaO reaction to occur as a result of feeding agglomerates with sufficient strength into the calciner.

It is an object of the present invention for the rotary kiln calciner to not require internal chains.

It is an object of the present invention for the above process to greatly reduce or eliminate a precoat filter to condition the SLS sludge.

It is an object of the present invention for the above process to eliminate a suspension preheater.

The present invention relates to a product from reclaiming spent lime sludge (SLS) which consists essentially of calcium carbonate (CaCO₃) particles, water and other particulate, wherein the process for making the product comprises bringing all contents of the SLS sludge into a mixer; adding dry recycle along with a binder to the SLS sludge to form calcium carbonate agglomerates; predrying; followed by calcining of the sludge.

It is an object of the present invention for the product to have one or more of the following particulates thermally decomposed in the process: PCB's, Furans, or dioxins.

It is an object of the present invention for the recovery of spent lime sludge (SLS) to also include polyacrylamide.

The present invention can treat (recover) spent lime sludge cake (SLS) with over 40% moisture content and over 10% magnesium carbonate content. This is a combination unobtainable in conventional lime recovery rotary kilns. In doing so, greater CaO yields are also achieved. The present invention relates to the ability and method to pre-treat feed materials not amenable to processing in conventional rotary kilns. In essence the present invention will condition the wet, sticky feed with dry solids to form an agglomerate that is readily processed in a kiln.

In the present invention spent slime sludge (SLS) that is traditionally difficult to handle is fed into a mixer along with dried recycle (either calcium carbonate or calcium oxide). The mixer used in the present invention was a Feeco International, Inc pug mixer. The mixer was selected because of the intimate mixing capability and ability to make small agglomerates having a diameter of 0.05 to 0.5 in. The spent lime sludge does not need to be predried. No pretreatment is required. There can be one piece of equipment to do both the mixing and agglomerating or several pieces of equipment to do the mixing and agglomeration in separate phases. While, the preferred method of the invention is to take mechanically dewatered sludge into the pretreatment process, higher moisture content sludge can also be handled by increasing the amount of dry recycle. The amount of recycle is dependent on specific sludge content. The purpose of blending dry recycle with the wet sludge is to reduce the combined moisture content of the sludge. A reduced moisture content sludge has: improved material handling characteristics; forms better agglomerates; and reduces fines losses from kilns.

Binders and other materials can be also added at the mixing stage of the process. A binder such as starch may be added to increase agglomerate strength. A strengthened pellet with a good binder reduces fines later on in the drying and calcination stages of the process. Using the right binder is critical in being able to maintain the agglomerate as long as possible through both the drying and the reactive stage of the process. In some cases fines may be acceptable to the end product so no binder may be needed.

The resultant agglomerates can be dried in a conventional rotary dryer where they are handled much more gently than in the chain section of a conventional lime recovery kiln. The lifting flights are designed to drop the agglomerates onto a rolling bed of material to minimize breakage. Even more importantly, agglomerates in the rotary dryer are less likely to shatter than in a kiln. If agglomerates with moisture dry too rapidly as in the case of a kiln, they will prematurely dry the outer shell (much like an eggshell) sealing in moisture. The moisture must escape and in doing so cracks/shatters the exterior wall. This process creates excessive fines. Rotary dryers slowly raise temperature of the sludge allowing internal moistures to be released less rapidly. Rotary dryers also ensure that the SLS entering the kiln is dry or nearly dry and has a material handling characteristic that is preferred for transport through the remaining kiln. Showering of agglomerates through the gas stream in a rotary dryer is more thermally efficient than drying in the chain section of a kiln.

Another option exists is to combine the predrying of said agglomerates with the calcining function in a single kiln vessel by adding lifters in the feed end section of a rotary kiln. While the benefits of a moistureless kiln are less, the process of forming wet agglomerates still has benefits where space constraints may not allow for the placement of a rotary dryer.

Agglomerates which have for the most part maintained their initial size are typically fed directly into a counter current rotary kiln for calcination. In special circumstances a parallel flow kiln may be used. As no water is present, the invention eliminates the need for chains, which are maintenance items, in rotary kilns. Because of the larger average particle size, exhaust gas velocity from kilns can be much higher (e.g., 1500 fpm) which results in a smaller diameter kiln. In addition, since the drying is occurring in a rotary dryer the more expensive kiln can also be shorter and less expensive. The kiln can now be: smaller in diameter; shorter in length and require less maintenance as no chains are required. The potential for chain soda ball formation is eliminated.

Besides reducing cost, the process of recycle, agglomeration, drying and reacting is new to the industry and gives confidence to a lime recovery system in two ways. Material handling of these very difficult to work with SLSs is dramatically improved. What once no one wanted to handle and committed to sludge ponds, now is possible to be recovered.

Second, the percent lime recovery is dramatically improved. Being able to produce a higher percentage of lime recovery has obvious economic benefits.

The present invention provides capital and operational savings along with a superior reacted lime that was unable to be achieved with the previous industry art. By adding optional polyacrylamides, the CaO recovered efficiency is enhanced.

### BRIEF DESCRIPTION OF THE DRAWINGS

FIG. 1 illustrates a flow chart showing the process of the present invention.

### DETAILED DESCRIPTION OF THE DRAWINGS

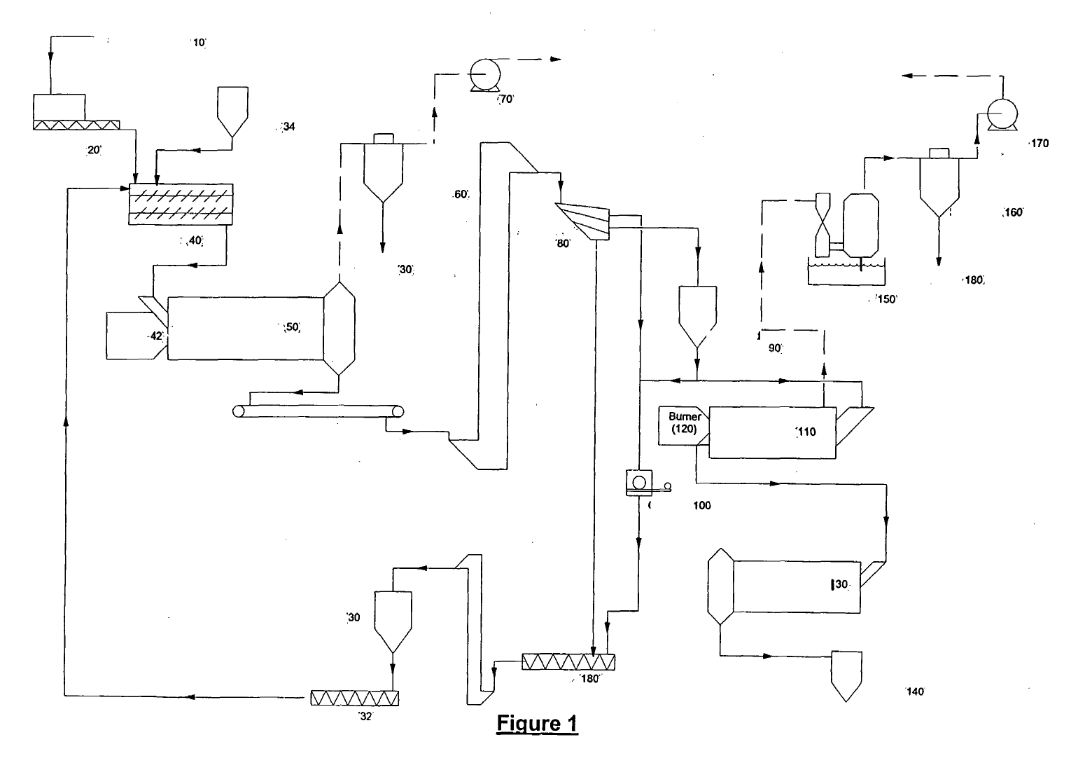

FIG. 1 shows sludge being sent from a front end loader 10 to a sludge feeder 20, the sludge has a moisture content of about 45% at this point. Dry sludge is sent through a dry sludge surge bin 30 where the sludge has a moisture content of about 3%. The dry sludge is sent through a weigh feeder 32 and put into a mixer/agglomerator 40, also adding to the mixer/agglomerator is a binder 34 and the sludge 10 from the sludge feeder 20. The binder 34 in a preferred embodiment is a starch. The sludge has a moisture content of about 31% after leaving the mixer/agglomerator. The sludge then goes into a rotary dryer 50 where heat input from the burner 42 and the rotary kiln are also placed in the rotary dryer 50. From the rotary dryer 50 all of the off gases go to a baghouse 60 and from the baghouse 60 they go into an ID fan 70 or to the dry sludge surge bin 30, at this point the dry sludge has a moisture content of about 3%. The other contents from the rotary dryer 50 go to a screen 80 when the contents leave the rotary dryer 50 they are at a moisture content of about 3%. From the screen 80 then it can go back to the dry surge bin 30 or can be placed in a kiln feed surge bin 90. From the kiln feed surge bin 90 the moisture content is about 3%. From the kiln surge bin 90 the product either goes into a crusher 100 which produces a dry sludge having about a 3% moisture content which product can then go back to the dry sludge surge bin 30. The product from the kiln feed storage bin 90 can also be placed in a rotary kiln 110, where product from a burner 120 is also placed in the rotary kiln 110 and the combined product is then placed in a cooler 130 to produce a lime product which can then be placed in storage 140. Off gases from the rotary kiln 110 can also be transported to a quench tower 150 or back to the rotary dryer 50. From the quench tower 150 the product can be placed in a bag house 160 which is then sent to an ID fan 170 or produces fines to product or recycle 180.

What is claimed is:

1. A process for lime recovery which consists essentially of calcium carbonate (CaCO₃) particles, water and other non-process elements NPEs;
wherein said process comprises:
bringing all contents of an SLS sludge into a mixer;
adding dry recycle along with a binder to said SLS sludge;
forming calcium carbonate agglomerates;
predrying said agglomerates; and
calcining said agglomerates.

2. The process of claim 1 further comprising:
adding a binding agent to said mixer, wherein said binder is selected from the group consisting of: Bentonite Clay, Polyacrylamides, Precipitated Calcium Carbonate, Sodium Silicate, Sodium Lignosulfonate, Molasses, Starch, Sugar, Hydrated lime, and any combination of the above.

3. The process of claim 1 further comprising spent lime sludge (SLS) with NPEs: selected from the group consisting of: sodium compounds, magnesium oxide, aluminum oxide, silicon dioxide, manganese oxide, iron oxides and any combination or concentration of the above.

4. The process of claim 1 wherein said mixer comprises at least two or more mixers or 1 mixer and 1 agglomerating piece of equipment.

5. The process of claim 1 where in the calcining takes place in one of the following calciners: Rotary Kiln, Fluid Bed, or Shaft Kiln

6. The process of claim 1 wherein said recycle contains one or more of:
calcium carbonate or calcium oxide.

7. The process of claim 1 wherein polyacrylamides are added to said process.

8. The process of claim 1 wherein said SLS sludge contains one or more of PCB's, Furans, or Dioxins.

9. The process of claim 1 wherein dust is minimized in said calciner.

10. The process of claim 1 wherein buildup is eliminated/minimized in said calciner.

11. The process of claim 1 wherein a greater calcium carbonate to CaO reaction occurs as a result of feeding agglomerates with sufficient strength into said calciner.

12. The process of claim 1 wherein said rotary kiln calciner does not require internal chains.

13. The process of claim 1 wherein a precoat filter to condition said SLS sludge is greatly reduced in size or eliminated.

14. The process of claim 1 wherein a suspension preheater is eliminated from said process.

15. The process of claim 1 where the predrying of said agglomerates and the calcining of said agglomerates takes place in a single vessel.

16. A product from spent lime sludge (SLS) recovery which consists essentially of calcium carbonate (CaCO₃) particles, water and other NPEs, wherein said process for producing said product comprises bringing all contents of said SLS sludge into a mixer; adding dry recycle along with a binder to said SLS sludge to form calcium carbonate agglomerates; predrying; followed by calcining.

17. The product of claim 16 wherein one or more of the following particulates are thermally decomposed in the process: PCB's, Furans, or dioxins

18. The product of claim 16 wherein recovery of spent lime sludge (SLS) that also includes polyacrylamide.
